(19) United States
(12) Patent Application Publication
(10) Pub. No.: US 2023/0136294 A1
(43) Pub. Date: May 4, 2023

(54) SYSTEMS AND METHODS FOR A TRUCK BED DIVIDER

(71) Applicant: TriEnda Holdings, LLC, Portage, WI (US)

(72) Inventor: Joshua G. Bauer, Sun Prairie, WI (US)

(21) Appl. No.: 17/978,895

(22) Filed: Nov. 1, 2022

Related U.S. Application Data
(60) Provisional application No. 63/274,371, filed on Nov. 1, 2021.

(51) Int. Cl. B60P 7/14; B62D 33/02

(52) U.S. Cl. CPC B60P 7/14; B62D 33/0207

(57) ABSTRACT

A divider body for a vehicle can include first and second body members. A first protruded area can be formed in an internal surface of the first body member and mating area can be formed in an internal surface of the second body member. The mating area can be opposite the first protruded area in a transverse direction. An attachment element can be transversely aligned with the first protruded area. The attachment element can be configured to secure an external accessory relative to the divider body. The first and second body members can form an internal volume therebetween and the first protruded area and the mating area can be in contact so that the internal volume surrounds an engagement of the first protruded area and the mating area.

### CROSS-REFERENCE TO RELATED APPLICATIONS

This application claims priority to U.S. provisional patent application No. 63/274,371, “Systems and Methods for a Truck Bed Divider” and filed on Nov. 1, 2021, the entirety of which is incorporated herein by reference.

### STATEMENT REGARDING FEDERALLY SPONSORED RESEARCH

Not Applicable.

### BACKGROUND

It can generally be useful to carry items, such as tools, accessories, packages, or other vessels, for example, in the bed of a pickup truck or general cargo space of a vehicle. Often, if items are not secured or restrained in place within the bed, they can slide around while the vehicle is in motion, causing noise and possibly damaging the items and/or the vehicle while also being susceptible to theft. Conventional truck bed organizing structures, such as truck boxes, can be used to restrain or secure items, but generally occupy a significant amount of storage space within the truck bed, thereby limiting the available space for items larger than the truck box, such as lumber, for example. A need exists for a truck bed divider that can selectively contain, secure, and/or anchor items within a truck bed.

### BRIEF SUMMARY

This system provides a customizable cargo divider that can be slidably secured to a cargo area, such as a truck bed, for example.

In some embodiments, aspects of the present disclosure provide a customizable truck bed divider for use in a pickup truck. The customizable truck bed divider can be configured as a twin sheet plastic divider having a plurality of transversely pinched surfaces that form a ribbed and recessed section. One or more of the transversely pinched surfaces can include one or more of an attachment feature, such as a through-hole or a protrusion, to allow for the use of accessory attachment device.

Some embodiments provide a divider body for a vehicle. The divider body can include first and second body members. A first recessed area can be formed in an external surface of the first body member and a second recessed area can be formed in an external surface of the second body member. The second recessed area can be opposite the first recessed area in a transverse direction. An attachment element can be disposed within the first recessed area. The attachment element can be configured to secure an external accessory relative to the divider body. The first and second body members can form an internal volume therebetween and the first recessed area and the second recessed area can be in contact so that the internal volume surrounds an engagement of the first and second recessed areas.

Some embodiments provide a divider body for a vehicle. The divider body can include first and second body members. A first protruded area can be formed in an internal surface of the first body member and a mating area can be formed in an internal surface of the second body member. The mating area can be opposite the first recessed area in a transverse direction. An attachment element can be disposed within the first protruded area. The attachment element can be configured to secure an external accessory relative to the divider body. The first and second body members can form an internal volume therebetween and the first protruded area and the mating area can be in contact so that the internal volume surrounds an engagement of the first protruded area and the mating area.

Some embodiments provide a divider assembly for a truck bed. The truck bed can define a lateral direction that extends between rear wheel wells and a transverse direction that extends between a front and back of the truck, the lateral direction being perpendicular to the transverse direction. The divider assembly can include a truck bed liner and a divider body. The truck bed liner can include a pair of opposing lateral channels. The divider body can be dimensioned to extend laterally across the truck bed. The divider body can include a first lateral end dimensioned to be slidably received within one of the opposing lateral channels of the truck bed liner. The divider body can include a second lateral end dimensioned to be slidably received within one of the other of the opposing lateral channels of the truck bed liner. The divider body can further include at least one recessed area formed in an external surface of the divider body. The divider body can further include at least one transverse support that extends within an internal volume of the divider body. The internal volume can be formed by an internal surface of the divider body.

Some embodiments provide a method of manufacturing a cargo divider for a vehicle. The method can include forming, in a first body member, at least one support structure that defines a recessed area in an external-facing surface of the first body member and a corresponding protruded area in an internal-facing surface of the first body member. The method can further include, forming, in a second body member, at least one support surface that defines a mating area in an internal-facing surface of the second body member. The method can further include securing the first body member to the second body member so that the protruded area of the first body member is mated with the mating area of the second body member to form the cargo divider. Each of the internal-facing surfaces of the first and second body members can define an internal volume of the cargo divider and the cargo divider can include a pair of opposing lateral ends that are dimensioned to be slidably received within the vehicle.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a perspective view of a divider body and a truck bed liner installed in a pickup truck according to embodiments of the present disclosure.

FIG. 2 is an exploded isometric view of the divider body and truck bed liner of FIG. 1.

FIG. 3 is an isometric view of the truck bed liner of FIG. 1.

FIG. 4 is a front isometric view of the divider body of FIG. 1.

FIG. 5 is a rear isometric view of the divider body of FIG. 1, the divider body including a plug.

FIG. 6 is an isometric view of the plug of FIG. 5.

FIG. 7 is a front cross-sectional isometric view of the divider body taken along line 7-7 of FIG. 5.

FIG. 8 is a front cross-sectional view of the divider body partially filled with a weighted material according to embodiments of the present disclosure.

FIG. 9 is a front elevational view of the divider body partially filled with the weighted material of FIG. 8.

FIG. 10 is a front isometric partial view of the divider body of FIG. 1 with an attachment element installed therein according to embodiments of the present disclosure.

FIG. 11 is a front isometric partial view of the divider body of FIG. 1 with another attachment element installed therein according to embodiments of the present disclosure.

FIG. 12 is an isometric view of the divider body and truck bed liner of FIG. 1 with an accessory secured relative to the divider body according to embodiments of the present disclosure.

FIG. 13 is a rear isometric partial view of the divider body of FIG. 1 with an attachment element installed therein according to embodiments of the present disclosure.

FIG. 14 is an isometric view of the divider body with an accessory secured relative to the divider body according to embodiments of the present invention.

FIG. 15 is a perspective view of the divider body, the truck bed liner, and a bed cover installed on a pickup according to embodiments of the present disclosure.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some implementations, devices, systems, or assemblies disclosed herein can be utilized, manufactured, or installed using methods embodying aspects of the invention. Correspondingly, any description herein of particular features, capabilities, or intended purposes of a device, system, or assembly is generally intended to include disclosure of a method of using such devices for the intended purposes, a method of otherwise implementing such capabilities, a method of manufacturing relevant components of such a device, system, or assembly (or the device or system as a whole), and a method of installing disclosed (or otherwise known) components to support such purposes or capabilities. Similarly, unless otherwise indicated or limited, discussion herein of any method of manufacturing or using for a particular device, system, or assembly, including installing the device, system, or assembly is intended to inherently include disclosure, as embodiments of the invention, of the utilized features and implemented capabilities of such device, system, or assembly.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to front, rear, side, downward, or top (or other) positions or directions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

As briefly described above, it can be generally useful to carry a variety of items, such as tools, accessories, packages, or other vessels, for example, in the bed of a pickup truck or general cargo space of a vehicle. In many instances, if items are not secured or restrained in place within a truck bed or other cargo space, they can slide around and cause noise, damage, or unwanted vibration to the items or the cargo space, particularly when the vehicle is in motion. Conventional cargo organizers that can secure items often occupy a significant amount of volume within the cargo space. Such cargo organizers limit the available space in the cargo area of a vehicle and can often only restrain cargo that fits within the organizer, leaving larger items unrestrained.

Embodiments of the present disclosure address these and other drawbacks. In particular, embodiments of the invention can provide a cargo divider that can divide a cargo space, such as a truck bed, for example, and provide one or more anchor points to which items, such as tools, accessories, packages, or other vessels can be secured to. In some instances, these items can be fully contained (e.g., supported by) the cargo divider. In other instances, items may be secured relative to the divider while resting on a floor or other surface of the cargo space and being limited from movement within the cargo space.

Embodiments of the present disclosure can also provide a cargo divider that is customizable. For example, a cargo divider according to embodiments of the present disclosure can include one or more attachment elements that can be moved or customized depending on the cargo to be secured. For example, the cargo divider can optionally include one or more of anchors, hooks, brackets, shelves, or compartments that can be selectively coupled and decoupled from the cargo divider. Embodiments of the present disclosure can also provide a cargo divider that includes lateral flanges that prevent movement of the cargo divider in a transverse direction (e.g., forward and backward relative to a truck bed). The lateral flanges can provide support to the entire cargo divider and reduce flexure of the cargo divider in the transverse direction, which can aid in securing items within a cargo space and reduce unwanted wear on the cargo divider.

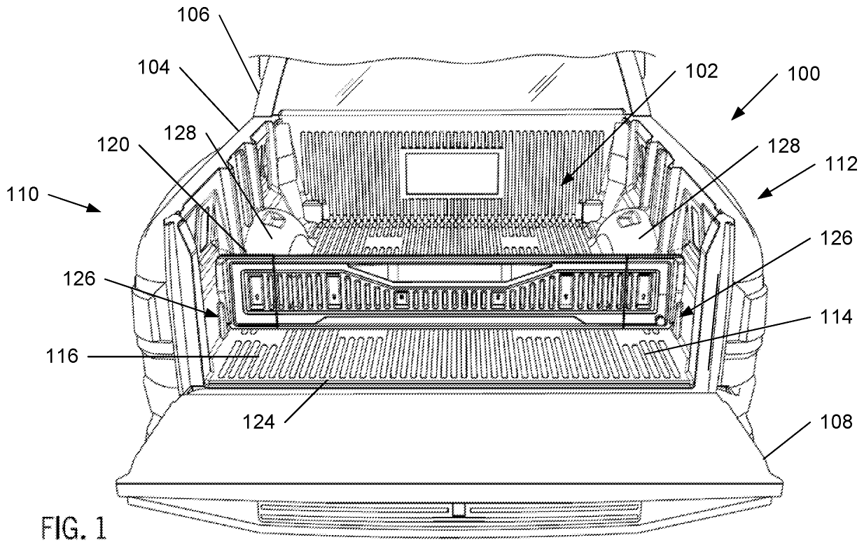

With reference now to FIG. 1, embodiments of the present disclosure provide a divider assembly 100 for a cargo space 102. In the illustrated embodiment, the cargo space 102 is configured as a truck bed for a truck 104, however, other cargo spaces are possible. For example, a cargo space may exist in other vehicles, such as cars (e.g., sedans), vans, all-terrain vehicles (i.e., ATVs), trailers, aircrafts, and watercrafts.

In the illustrated example, the truck 104 includes a truck cabin 106, a tailgate 108, a first lateral side 110, and a second lateral side 112. The truck 104 can further define a lateral direction that extends between the first and second lateral sides 110, 112, and a transverse direction that extends between the truck cabin 106 and the tailgate 108. The lateral direction and the transverse direction can be substantially perpendicular. The truck 104 can further define a truck bed 114 between the first and second lateral sides 110, 112 having a truck bed floor 116. The truck bed floor 116 can be substantially perpendicular to a vertical direction that extends upwards from the truck bed floor 116, relative to FIG. 1. The vertical direction can be substantially perpendicular to each of the lateral direction and the transverse direction.

The divider assembly 100 can include a divider body 120 and a truck bed liner 124. In other embodiments, a divider assembly can include a divider body and a cargo liner that is configured to line a cargo space of a variety of vehicles, such as the vehicles described above. In the illustrated example, the truck bed liner 124 can be secured relative to the truck bed 114 and extend across the truck bed floor 116 and at least partially up the lateral sides 110, 112 within the truck bed 114. The truck bed liner 124 may be fixed relative to the truck bed 114 via one or more of a snap fit, interference fit, fasteners, or adhesive. In general, the truck bed liner 124 can provide anchor points for the divider body 120 so that the divider body 120 is fixed relative to the truck bed 114 (or in other examples, a cargo space). The truck bed liner 124 can fix the divider body 120 in the transverse direction so that the divider body is not movable relative to the truck cabin 106 or the tailgate 108. Additionally, the truck bed liner 124 can secure the divider body 120 in the lateral direction and resist movement of the divider body 120 in the vertical direction.

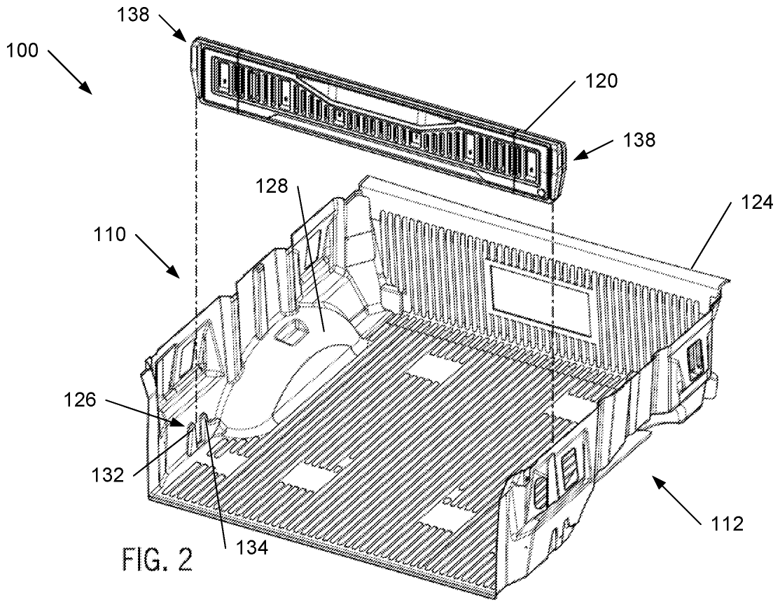

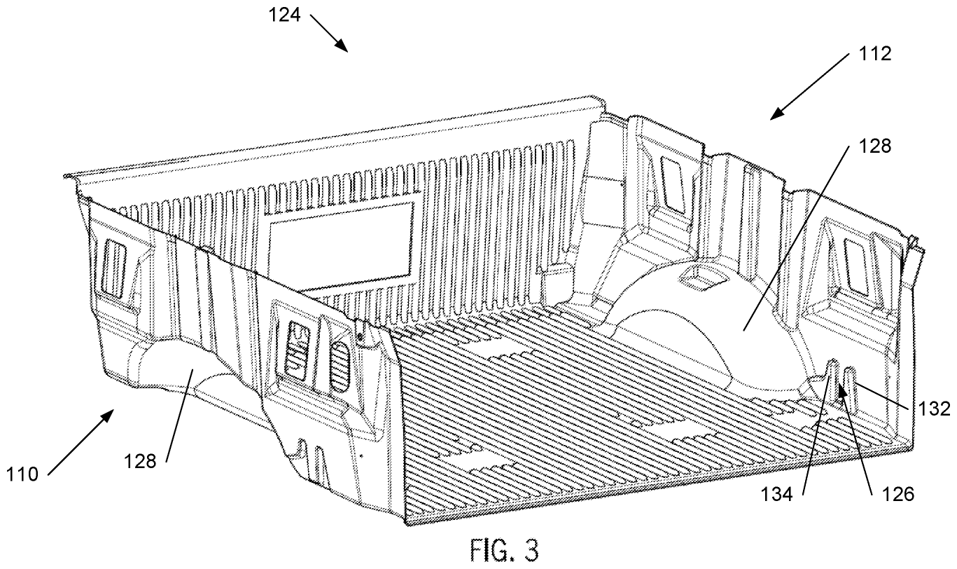

With reference to FIGS. 2 and 3, the truck bed liner 124 can include a pair of lateral channels 126. The lateral channels 126, which may generally be configured as pockets, can be disposed at the first and second lateral sides 110, 112 of the truck bed liner 124 near the truck bed floor 116. In the illustrated embodiment, the lateral channels 126 are located behind the wheel wells of the truck 104 (i.e., between the wheel wells 128 and the tailgate 108). However, in other embodiments, the channels 126 may be positioned in other transverse positions along the lateral sides 110, 112 of the truck bed liner 124. For example, the channels 126 (or additional channels) may be disposed in front of the wheel wells 128 (i.e., between the wheel wells 128 and the truck cabin 106), on the wheel wells 128, and/or between the wheel wells 128.

In some embodiments, the divider body 120 can be equipped with a tie (such as a cable, rod, rope, etc.) that is connected to the tailgate 108. In use, the tie can prevent the tailgate from opening completely, and instead can tether the tailgate 108 so that it can remain in a partially opened position (i.e., a position between fully closed and fully open, such as at a 30°, 45°, or 60° from a vertical or horizontal orientation). In some embodiments, the retained and partially opened position of the tailgate 108 can align an edge of the tailgate 108 with one or more of a surface or area of the divider body 120 or a top of the wheel well 128. The alignment of an edge of the tailgate 108 with a surface of the divider body 120 or wheel well 128 can facilitate the loading, unloading, and transport of larger cargo items that may not fit, particularly in a planar position, between the wheel wells 128. For example, a sheet of plywood, sheetrock, or other large cargo may be held in a planar position or otherwise secure position by extending between the edge of the partially opened tailgate and one or more of the divider body 120 or wheel well.

In some examples, the channels 126 may be integrally (e.g., unitarily) formed with the truck bed liner 124. However, in other examples, the channels 126 may be movable relative to the lateral walls 110, 112 of the truck bed liner and can be selectively secured relative to the truck bed 114 to provide a customizable divider position for the divider body 120. As illustrated in FIG. 2, the channels 126 can be configured to slidably receive the divider body 120. In use, the divider body 120 can be positioned to extend laterally across the truck bed 114, generally perpendicular to the lateral sides 110, 112, and moved downward in the vertical direction to engage the channels 126 (and correspondingly moved upward in the vertical direction to disengage from the channels 126).

With continued reference to FIGS. 2 and 3, the channels 126 are formed by a first wall 132 and a second wall 134. The portion of the first and second walls 132, 134 that face the channel 126 are substantially parallel and are dimensioned to engage lateral ends 138 of the divider body 120. The portion of the first and second walls 132, 134 that face the channel 126 can include protrusions, dimples, or other features that can engage the lateral ends 138 of the divider 120 to provide a tactile confirmation when the divider body 120 is secured within the channels 126 and/or a restraint to secure the divider body 120 in the vertical direction relative to the truck bed liner 124.

Further, as shown in FIGS. 2 and 3, the channels 126 can include an opening through which the divider body 120 can pass when engaging or disengaging with the truck bed liner 124. In some embodiments, when the divider body 120 is in an installed configuration (see, for example, FIG. 1), the lateral ends 138 of the divider body 120 extend vertically past the opening. However, in other embodiments, the channels 126 may define a vertical height so that when the divider body 120 is in an installed configuration, the lateral ends 138 of the divider body 120 are seated below the opening. In the embodiment where the lateral ends 138 of the divider body 120 are seated below the opening, a lock may extend across the opening to secure the divider body 120 relative to the truck bed liner 124 and prevent removal or theft. In other embodiments, a lock, such as a pin or other retainer, may extend in the transverse direction through at least one of the channel walls 132, 134 to secure the divider body 120 relative to the truck bed liner 124 and prevent unwanted removal of the divider body 120 from the channels 126.

In some embodiments, the channels 126 may define a width (i.e., in the transverse direction) that can allow for the divider body 120 or a variety of other items to slide in and out of engagement with the truck bed liner 124. For example, the channels 126 may be dimensioned to accommodate other divider structures or cargo, such as lumber (e.g., a 2×4 or other dimensioned boards). In this regard, the divider assembly 100 may include the divider body 120 and a truck bed liner that can be retrofitted to accommodate the divider body 120, the truck bed liner being previously dimensioned to secure other cargo.

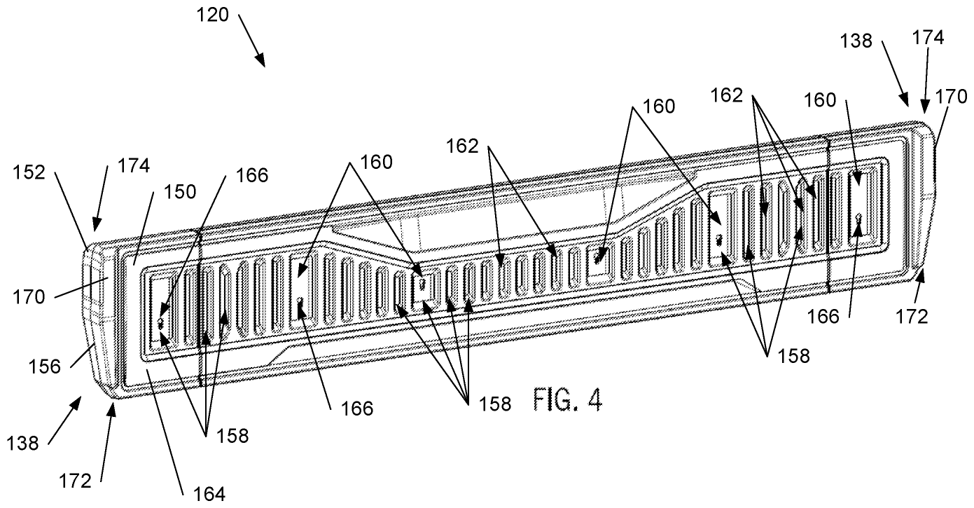

With reference to FIG. 4, the divider body 120 can be formed from a first body member 150 and a second body member 152. In the illustrated example, the first and second body members 150, 152 can be mated at a seam 156 (e.g., a weld joint). Each of the first and second body members 150, 152 can include one or more recessed areas 158. Some of the recessed areas 158 can be configured securement recessed areas 160 and some of the recessed areas 158 can be configured as support recessed areas 162. It should be appreciated that any of the recessed areas 158 may generally provide support to the structure of the divider body 120, and that the designation of a “support” or a “securement” recessed area is simply to highlight the accessory attachment features of the securement recessed areas 160. Relatedly, any of the support recessed areas 162 can incorporate attachment features, such as hooks, knobs, dimples, tracks, openings, holes, etc. to provide securement or attachment features. The recessed areas 158 may generally be recessed (e.g., sunken) relative to a main body surface 164.

In the illustrated embodiment, the securement recessed areas 160 can include through-holes 166 that extend through each of the first and second body members 150, 152 in the lateral direction. The through-holes 166 can generally be configured as attachment elements or can be dimensioned to receive attachment elements (e.g., hooks, knobs, holders, etc.). As shown, each securement recessed area 160 includes a single through-hole 166, however, in other embodiments, other configurations are possible. For example, a securement recessed area 160 can include a plurality of through-holes or other attachment elements.

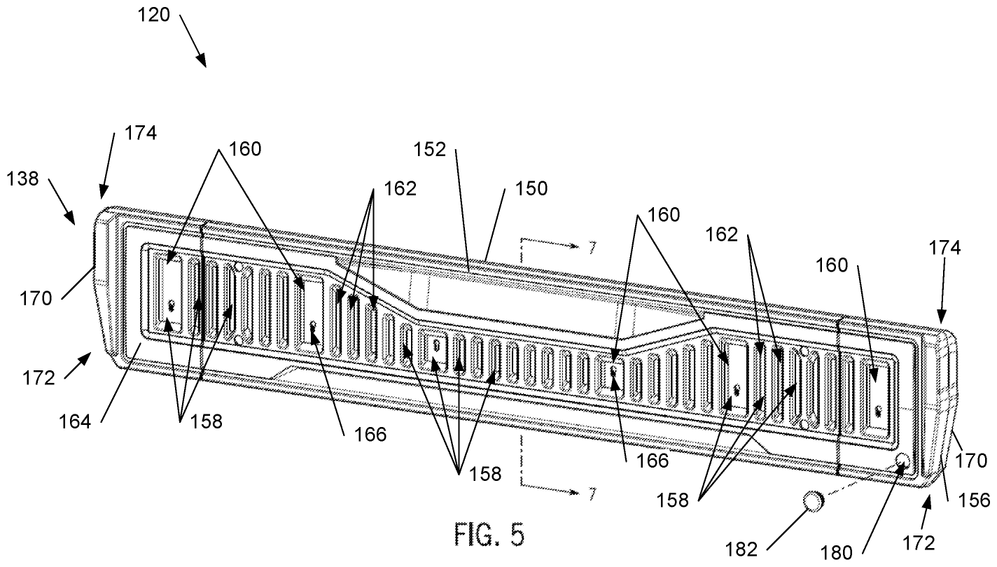

As shown collectively in FIGS. 4 and 5, each of the recessed areas 158 formed in the first body member 150 align with the recessed areas 158 formed in the second body member 152. That is, the recessed areas 158 formed in an external surface of the first body member 150 are opposite the recessed areas 158 in the transverse direction. In this regard, in some embodiments, the first and second body members 150, 152 can define substantially the same geometry and therefore can be manufacturing using the same or a similar mold. Relatedly, each of the first and second body members 150, 152 can define a respective perimeter where the body members 150, 152 meet at the seam 156. The respective perimeters can define the same geometry.

Still referring to FIGS. 4 and 5, the divider body 120 can include a pair of side flanges 170. The side flanges 170 are disposed at the lateral ends of the divider body 120 and extend generally forward and backward in the transverse direction away from the main body surfaces 164 of each of the first and second body members 150, 152. The side flanges 170 can be collectively formed by sub-flanges of the first and second body members 150, 152. For example, during a manufacturing process, the first body member 150 may be integrally formed to include a pair of sub-flanges on opposing lateral ends and the second body member 152 may be integrally formed to include the other pair of sub-flanges on opposing lateral ends. When the first and second body members 150, 152 are secured together to form the divider body 120, the sub-flanges collectively form the side flanges 170.

The side flanges 170 can define a taper such that the extend between a narrow portion 172 and a wide portion 174. In use, the tapered geometry of the side flanges 170 can help form an interference fit between the divider body 120 and the lateral channels 126 of the truck bed liner 124. The interference fit can facilitate installation and removal of the divider body 120 from the truck bed liner 124. For example, the divider body 120 can be installed in (and similarly disengaged from) the truck bed liner 124 without tools or external fasteners. Additionally, the taper geometry can help ensure that the divider body 120 remains in an installed configuration, particularly when the truck 104 (or other vehicle) is in use and the cargo space 102 is susceptible to vibrations.

While FIG. 4 illustrates the divider body 120 with the first body member 150 in the foreground, and FIG. 5 illustrates the divider body 120 with the second body member 152 in the foreground, it should be appreciated that the divider body 120 can be reversible. In particular, the divider body 120 can be installed in a vehicle, such as the truck 104 with either the first body member 150 facing the tailgate 108 or the first body member 150 facing the truck cabin 106. The reversibility of the divider body 120 is facilitated by the mirrored geometry of the first and second body members 150, 152. Additionally, the reversibility of the divider body 120 can allow for customization of the divider body 120, such as, for example, reversing the orientation of the divider body 120 based on attachments secured at the securement recessed area 160 that may be preferentially accessed from different sides of the cargo space 102 depending on use or environment. Relatedly, the securement recessed areas 160 can be utilized on either (or both) of the first and second body members 150, 152.

With reference to FIG. 5, the divider body 120 can further include an opening 180. As shown, the opening 180 can be dimensioned to receive a plug 182. In general, the divider body 120 can be configured as a hollow body (although, notably not hollow internally behind the securement recessed areas 160 and the support recessed areas 162 in the transverse direction, as shown in FIG. 7). The hollow body of the divider body 120 can define an internal volume that, in some embodiments, can be configured to optionally receive an external material therein. When the plug 182 is secured relative to the divider body 120, the internal volume may be sealed off from the external environment. The plug 182, in combination with the fixation of the first body member 150 and the second body member 152, provides an impenetrable body that can prevent unwanted material, such as waterer, dust, dirt, for example, from entering the internal volume.

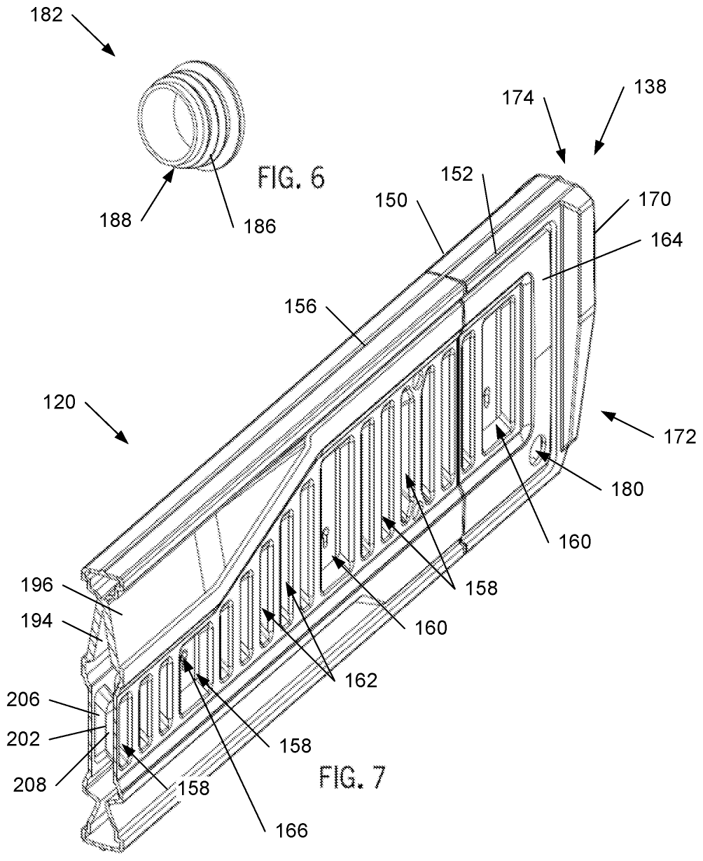

As shown in FIG. 6, the plug can include one or more annular grooves 186 formed on a stem portion 188 of the plug 182. The stem portion 188 can form a seal with the opening 180 so that the internal volume is sealed when the plug 182 is in an installed orientation. In some embodiments, the plug 182 can include a seal (e.g., a gasket) to provide the seal with divider body 120. It may be generally advantageous to prevent debris and/or liquid from entering the internal volume to reduce wear and tear to the divider body 120. For example, some conventional cargo dividers may allow an ingress of water (e.g. rainwater) that can then get trapped within the cargo divider and can expand in freezing temperatures and cause stress on the cargo divider, thereby disadvantageously weakening the cargo divider.

With reference to FIG. 7, the internal volume of the divider body 120 is bounded by an internal surface 194. The internal surface 194 is opposite an external surface 196 of the divider body 120. As further shown in FIG. 7, the recessed areas 158 (i.e., a front recessed area formed in the first body member 150 and a rear recessed area formed in the second body member 152) are in contact with the transversally opposite recessed area 158. The recessed areas 158 are in contact within the internal volume to form an engagement 202, and thus, a transverse support structure. The internal volume of the divider body 120 surrounds the engagement 202 and no air (or other material) is trapped between the recessed areas 158 in the transverse direction. The engagement 202 of the recessed areas 158 forms a solid column-like support structure extending in the transverse direction.

During a manufacturing process, the first and second body members 150, 152 may be formed from a material, such as a plastic. The plastic may include, for example, high-density polyethylene (HDPE), polypropylene plastics, or acrylonitrile butadiene styrene (ABS); however, a variety of other materials may be suitable. The first and second body members 150, 152 may be formed via a variety of manufacturing processes, including thermoforming. During a thermoforming process, an unformed sheet of material may be heated to a pliable temperature and formed into the shape for the first and second body members 150, 152. In some embodiments, a single mold may be used to form individually the first and second body members 150, 152 which can save both time and money during tooling and production.

Once each of the first and second body members 150, 152 are formed, the body members 150, 152 may be oriented so that their respective internal surfaces 194 face each other and pressing tool (not shown) can press or pinch the recessed areas 158 of the first body member 150 into the corresponding recessed areas 158 of the second body member 152. As shown in FIG. 7, the recessed areas 158 are recessed with respect to the external surface 196 of the divider body 120 and correspondingly form first and second protruded areas 206, 208 (e.g., plateaus) that are protruded with respect to the internal surface 194.

However, in other embodiments, the first protruded area 206 can engage a flat, planar, sunken, or otherwise non-raised mating surface of the second body member 152. In particular, in some embodiments, only one of the body members may include recessed areas 158 and an internal engagement to form one or more welded support structures inside the divider body 120 can be formed at a protruded area and a corresponding mating area. Additionally or alternatively, in some embodiments, the recesses (and corresponding protrusions) may alternate across the first and second body members 150, 152 so that each of the body members 150, 152 can include protruded areas to form an engagement with a corresponding mating area on the opposing body member.

The pressing process that can form the pinched engagement 202 of the protruded areas 206, 208 and the temperature of the first and second body members 150, 152 (or the pressing tool) during the pressing stage can weld the protruded areas 206, 208 together. In particular, a pair of corresponding protruded areas 206, 208 can be melted together so that the material forming the engagement 202 is slightly thinned. For example, the thickness of the divider body 120 in the transverse direction at the recessed areas 158 can be less than twice the thickness of the first body member 150 (or the second body member 152) before the body members were formed. In other words, the thickness of the internal support structures formed by the engagement of the protruded areas 206, 208 can be less than twice the thickness of the unformed (or unmolded) body members 150, 152. Still, in other embodiments, after mating a protruded area of one body member with a mating area of the other body member, the thickness of the divider body in the transverse direction at the recessed area can be less than the combined raw material thickness of both the first and second body members.

Further in the manufacturing process of the divider body 120, a secondary process can be used to form the through-holes 166 that extend in the transverse direction. The through-holes 166 can extend through the engagement 202 of the recessed areas 158, which can improve the strength of the attachment elements (e.g., the through-holes and external attachments, such as hooks, secured thereto). In general, the through-holes 166 extending through the engagement 202 of the recessed areas 158 provides a solid connection point to the divider body 120 as opposed to a connection that could cause flexure if it was connected to or extending from a hollow portion of the divider body 120.

Generally, the through-holes 166 can be formed via a cutting, milling, drilling, or punching process once the first body member 150 is secured relative to the second body member 152. In some embodiments, a computerized numerical control (CNC) manufacturing process can be used to form the through-holes 166. Advantageously, because of the engagement 202 of the protruded areas 206, 208, a through-hole 166 that extends through a securement recessed area 160 does not provide an opening to the internal volume of the divider body 120, and thus water or other debris is prevented from entering the divider body at or near the through-holes 166.

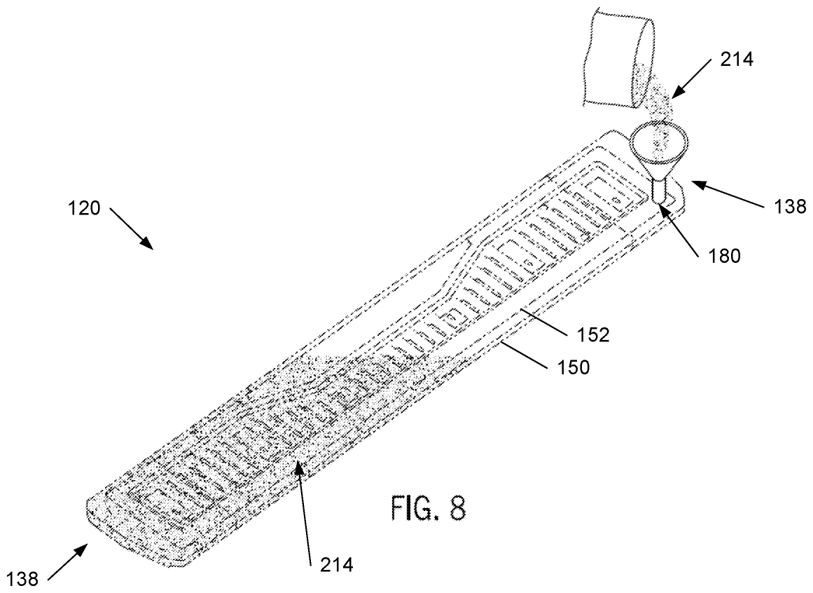

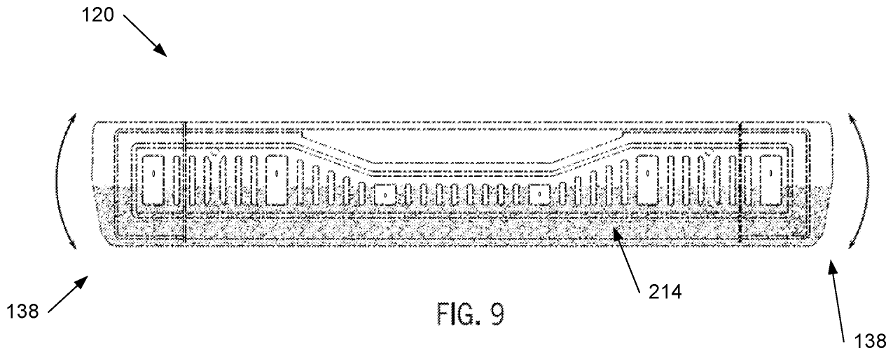

With reference now to FIGS. 8 and 9, in some embodiments, a weighted material 214 can be added to the internal volume of the divider body 120. The weighted material 214 can be sand, gravel, beads, water, etc. that can be distributed within the hollow portion of the divider body 120. In general, the weighted material 214 can act as a ballast for the vehicle (e.g., the truck 104), the truck bed liner, and/or the divider body itself 120. As shown in FIG. 8, the weighted material 214 can be optionally added to the divider body via the opening 180 and contained within the divider body via the plug 182. As shown in FIG. 9, the divider body 120 can be tipped to distribute the weighted material 214 within the internal volume. In a similar fashion, the plug 182 can be optionally disengaged from the opening 180 to remove or alter the amount of weighted material 214 within the internal volume.

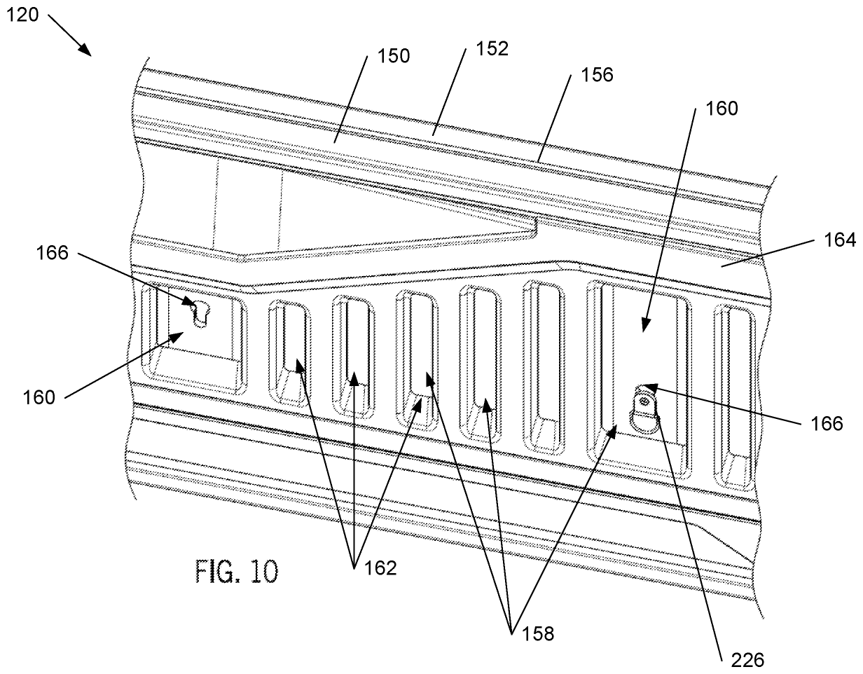

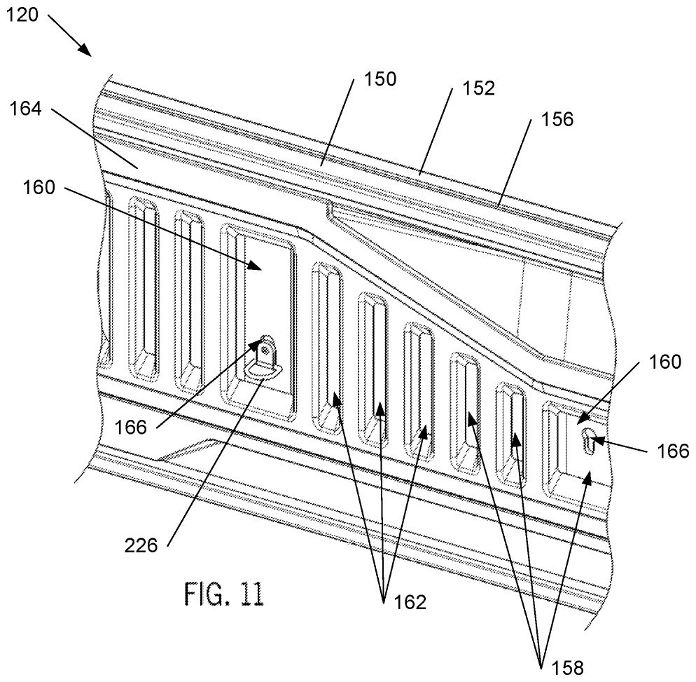

Turning now to FIGS. 10 and 11, as briefly described above, the securement recessed areas 160 can include through-holes 166. The through-holes 166 can be configured as key holes having a wide portion and a narrow portion. However, other geometries are possible and the shape of the through-holes (or alternatively, protrusions) can vary depending on the desired accessory attachment device to be used. In use, an attachment element 226 that can be inserted into the wide portion of the keyhole and slide into a locked engagement within the narrow portion. In the illustrated embodiment, the attachment element 226 is configured as a hook. As shown in FIG. 11, the attachment element 226 can include a pivotable ring that can lay against the securement recessed area 160 and optionally pivot for connecting with a hook or other latch body.

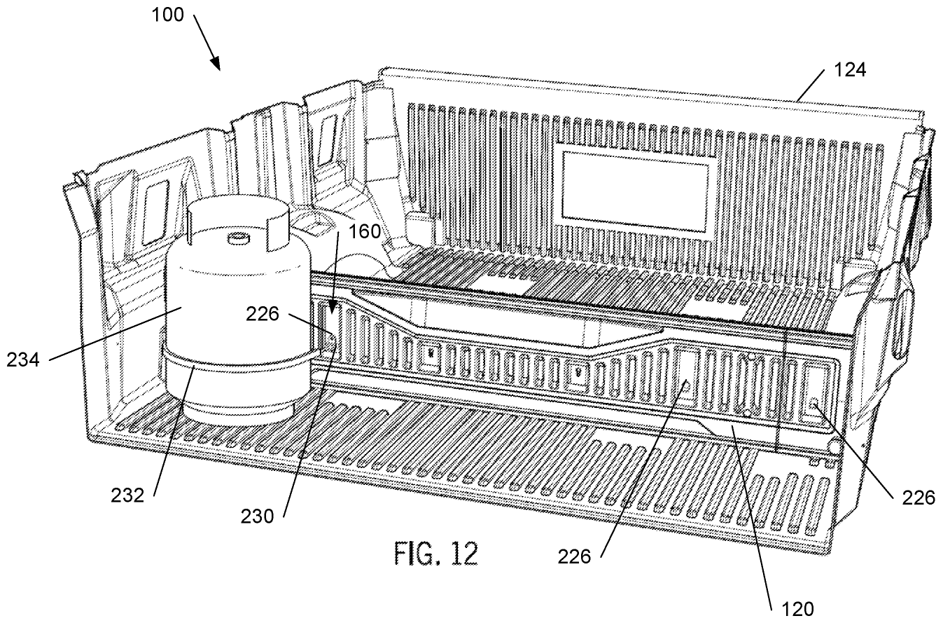

For example, with reference to FIG. 12, a hook 230 and a strap 232 can be used to secure cargo 234 relative to the divider body 120. In the illustrated example, the cargo 234 is configured as a tank (e.g., a propane tank). The strap 232 can optionally be attached to the divider at first and second locations and can prevent the cargo 234 from moving around within the cargo space (e.g., the truck bed liner 124), especially during transit. Additionally, the proximity of the divider body 120 to the tailgate 108 can facilitate easy access to the attachment elements 226 so that a user does not have to reach excessively far into the truck bed 114 in a transverse direction to secure the cargo.

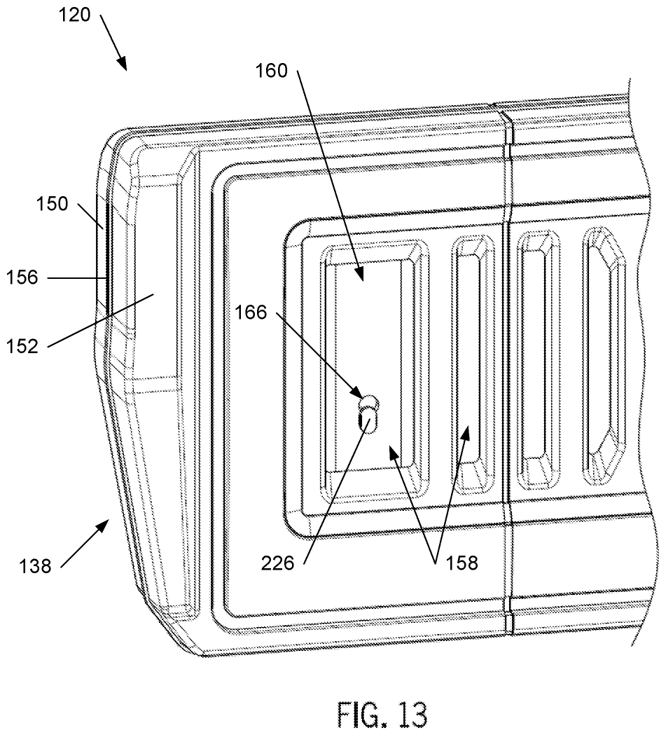

FIG. 13 illustrates a rear view of an attachment element 226 secured to the divider body 120. In general, the shape of the through-hole 166 allows for the attachment element 226 to extend fully through the divider body 120 thereby providing a strong connection at the securement recessed area 160. In general, a user can customize the configuration of attachment elements 226, and can even place attachment elements 226 on opposing sides of the divider. For example, in on configuration, one attachment element 226 may face the truck cabin 106 and one attachment element may face the tailgate 108. In this regard, a user can slide or otherwise move attachment elements 226 in and out of engagement with the divider body 120 depending on the cargo and types of attachments to secure the cargo or other accessories.

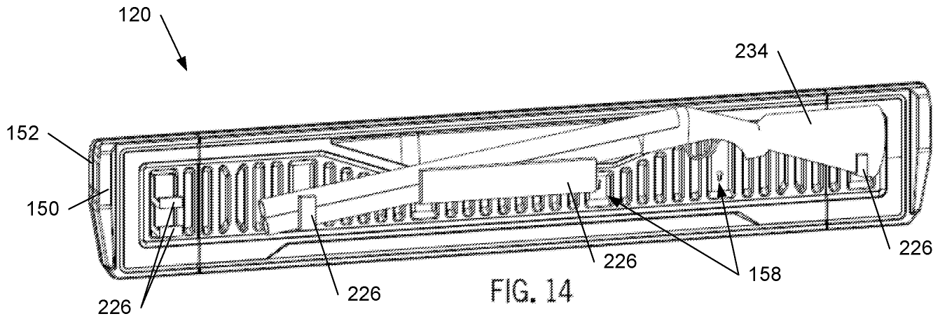

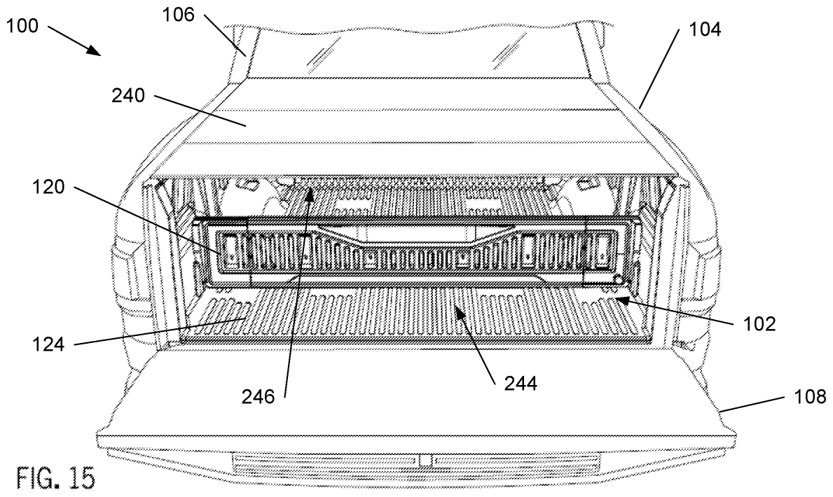

FIG. 14 illustrates another example of attachment elements 226 for the divider body 120. In particular, examples of the attachment elements 226 in FIG. 14 include holders (e.g., brackets) that can hold cargo 234 relative to the divider body 120. In some embodiments, advantageously, the attachment elements 226 can hold cargo off of the floor of the truck bed liner 124. This can help keep certain cargo, such as fragile cargo, clean and secured in the cargo space. In the illustrated example, the cargo 234 is configured as a firearm. However, a variety of other cargo can be fully contained (e.g., not resting on the floor of the bedliner) and/or secured relative to the divider body 120.

In general, the through-holes 166 can be dimensioned to slidably receive a protrusion, such as a protrusion of an attachment element 226. One or more attachment elements 226 can be used to secure or support cargo or other accessories relative to the divider body 120. Generally, an attachment element 226 can be configured as an accessory support and can include a hook, a bracket, or a compartment. Additionally or alternatively, an attachment element 226 can be an accessory, such as a light or other ornamental body. Further, in some embodiments, the geometry of through-holes can allow for an attachment element 226 to be secured relative to the divider body 120 so that the attachment element 226 is secured in the transverse direction and the lateral direction.

As briefly described above, additional or alternative dimensioned through-holes 166 are possible. In this regard, in some embodiments, an attachment element 226 may be secured in other ways to the divider body 120, including, for example, via a press fit or interference connection, a threaded connection, a nut a bolt connection, or combinations thereof. Advantageously, according to embodiments of the present disclosure, one or more attachment elements, accessories, or accessory supports can be configured in a custom arrangement relative to the divider body 120 depending on user preference and cargo containment requirements. In this regard, these attachment element, accessories, or accessory supports can be selectively coupled and decoupled to the divider body 120

FIG. 15 illustrates the divider assembly 100 including a truck bed cover 240. As shown, the divider body 120 can define a vertical height that is less than the lateral side walls of the truck 104 so that the divider body 120 does not interfere with the truck bed cover 240. Additionally, the divider body 120 can provide a supplemental rear wall structure that can allow a user to store cargo in the truck bed 114 against a rigid wall (i.e., the divider body 120) without having to fully remove the truck bed cover 240 to access a rigid wall (i.e., the wall behind the truck cabin 106). It can generally be useful to abut cargo against a wall to prevent unwanted movement, such as in the transverse direction.

Further, as shown in FIG. 15, the divider body 120 can fully separate the truck bed liner 124 into first and second areas 244, 246. The first area 244 being adjacent to the tailgate 108 and the second area 246 being adjacent to the truck cabin 106. The separation, particularly provided by the engagement of the side flanges 170 with the lateral channels 126, can prevent cargo, spills, or other debris from crossing the divider body 120 near the truck bed floor 116. This can keep cargo more contained and prevent items, particularly small items, from moving between the first area 244 and the second area 246 during transit, which can cause unwanted vibration and scattered cargo.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

What is claimed is:

1. A divider body for a vehicle, the divider body comprising:
a first body member;
a second body member;
a first protruded area formed in an internal surface of the first body member;
a mating area formed in an internal surface the second body member, the mating area opposite the first protruded area in a transverse direction; and
an attachment element transversely aligned with the first protruded area, the attachment element configured to secure an external accessory relative to the divider body,
the first and second body members forming an internal volume therebetween and the first protruded area and the mating area are in contact so that the internal volume surrounds an engagement of the first protruded area and the mating area.

2. The divider body of claim 1, wherein the first protruded area is formed in the internal surface of the first body and a complementary first recessed area is formed in an external surface of the first body opposite the first protruded area, and
wherein the mating area is configured as a second protruded area formed in the internal surface of the second body member.

3. The divider body of claim 1, wherein the attachment element configured as a through-hole that extends through each of the first protruded area, the mating area, and the engagement of the first protruded area and the mating area.

4. The divider body of claim 3, wherein the through-hole is configured as a keyhole that can slidably receive a protrusion and secure the protrusion relative to the divider body in the transverse direction and a lateral direction that is perpendicular to the transverse direction.

5. The divider body of claim 3, wherein the attachment element configured as the through-hole is one of a plurality of through-holes.

6. The divider body of claim 3, wherein the attachment element configured as the through-hole is dimensioned to receive an accessory support configured to secure an accessory relative to the divider body.

7. The divider body of claim 1, wherein each of the first and second body members include lateral side flanges dimensioned to be received by lateral channels to secure the divider body relative to the vehicle in the transverse direction.

8. The divider body of claim 1, wherein the first body member defines a first body perimeter and the second body member defines a second body perimeter, the first and second body perimeters defining the same geometry.

9. The divider body of claim 1, wherein at least one of the first body member or the second body member includes an opening to the internal volume, the opening dimensioned to receive a material that can occupy the internal volume.

10. The divider body of claim 9, wherein a removable plug is dimensioned to retain the material within the internal volume when the removable plug is secured relative to the first and second body members at the opening.

11. A divider assembly for a truck bed, the truck bed defining a lateral direction that extends between rear wheel wells and a transverse direction that extends between a front and back of the truck, the lateral direction being perpendicular to the transverse direction, the divider assembly comprising:
a truck bed liner having a pair of opposing lateral channels; and
a divider body dimensioned to extend laterally across the truck bed, the divider body including:
a first lateral end dimensioned to be slidably received within one of the opposing lateral channels of the truck bed liner;
a second lateral end dimensioned to be slidably received within the other of the opposing lateral channels of the truck bed liner;
at least one recessed area formed in an external surface of the divider body; and
at least one transverse support that extends within an internal volume of the divider body, the internal volume formed by an internal surface of the divider body.

12. The divider assembly of claim 11, further comprising at least one accessory support disposed in the at least one recessed area, the accessory support configured to secure an accessory relative to the divider body.

13. The divider assembly of claim 12, wherein the accessory support is configured as one or more of a hook, bracket, or compartment that can be selectively coupled and decoupled from the divider body.

14. The divider assembly of claim 11, wherein each of the pair of opposing lateral channels include a top opening to slidably receive the divider body.

15. The divider assembly of claim 11, wherein the at least one transverse support is aligned with the at least one recessed area in the transverse direction.

16. The divider assembly of claim 11, further comprising at least one through-hole that extends through the at least one recessed area, the through-hole extending in the transverse direction.

17. The divider assembly of claim 11, wherein the pair of opposing lateral channels are disposed behind the rear wheel wells in the transverse direction of the truck bed liner.

18. A method of manufacturing a cargo divider for a vehicle, the method comprising:
forming, in a first body member, at least one support structure that defines a recessed area in an external-facing surface of the first body member and a corresponding protruded area in an internal-facing surface of the first body member;
forming, in a second body member, at least one support surface that defines a mating area in an internal-facing surface of the second body member; and
securing the first body member to the second body member so that the protruded area of the first body member is mated with the mating area of the second body member to form the cargo divider, each of the internal-facing surfaces of the first and second body members defining an internal volume of the cargo divider and the cargo divider having a pair of opposing lateral ends that are dimensioned to be slidably received within the vehicle.

19. The method of claim 18, wherein after mating the protruded area of the first body member with the mating area of the second body member, thereby aligning the recessed area of the first body member and the mating area of the second body member in a transverse direction, the thickness of the cargo divider in the transverse direction at the recessed area is less than the combined thickness of the first body member and the second body member before the support structure and the support surface were formed.

20. The method of claim 18, further comprising:
forming a through-hole that extends in a transverse direction through each of the recessed areas of the first and second body members.
